(19) United States
(12) Patent Application Publication
(10) Pub. No.: US 2022/0057788 A1
(43) Pub. Date: Feb. 24, 2022

(54) END TO END SMART MANUFACTURING ARCHITECTURE FOR OPERATIONAL EFFICIENCY AND QUALITY CONTROL

(71) Applicant: Hitachi, Ltd., Tokyo (JP)

(72) Inventors: Prashanth AVIREDDI, Farmington, MI (US); Heming CHEN, Novi, MI (US); YiChu CHANG, Farmington Hills, MI (US); Wei YUAN, Novi, MI (US)

(73) Assignee: Hitachi, Ltd.

(21) Appl. No.: 16/998,618

(22) Filed: Aug. 20, 2020

(51) Int. Cl. G05B 19/418; G06N 20/00

(52) U.S. Cl. CPC G05B 19/41875; G05B 2219/32368; G06N 20/00

(57) ABSTRACT

Example implementation described herein are directed to systems and methods for management of a factory, which can include intaking and storing streaming sensor data from a plurality of edge nodes of the factory in a database server, the database server managing historical data of the plurality of edge nodes of the factory; executing, at an edge server, a first machine learning process on the streaming sensor data from the plurality of edge nodes to determine short term analytics; controlling, at the edge server, the plurality of edge nodes according to the determined short term analytics; executing, at a cloud server, a second machine learning process on the streaming sensor data stored in the database server and the short term analytics to determine long term analytics; and instructing the edge server to control the plurality of edge nodes according to the determined long term analytics.

### BACKGROUND

### Field

The present disclosure is generally directed to manufacturing systems, and more specifically, to end to end smart manufacturing architectures.

### Related Art

Smart Manufacturing is an industry revolution to upgrade the existing manufacturing system to increase productivity and efficiency through implementation of Internet of Things (IoT) driven tools which enhance use of the 4M factors (Man, Machine, Method and Material) data.

Globally, factories are focusing on IoT driven smart manufacturing to increase operational efficiency with the aid of real-time decisions to keep consistent track of the short-term and long-term goals. Implementing smart manufacturing Techniques will enable industries to improve productivity while consuming less energy, reducing product loss and optimizing manual effort, which in turn will help the push towards improved economic and environmental values.

In related art implementations, there is a significant push towards smart manufacturing Systems to reduce loss cost and increase operational efficiency of the factories. The goal is to reduce the energy and resource consumption of factories in a push towards eco-friendly production process. For a factory to operate at world-class efficiency, its OEE (operating equipment efficiency) should be at 85%, which indicates that the 4M (Man, Material, Machine and Method) are utilized efficiently with limited wastage of resources.

### SUMMARY

The example implementations described herein are directed to increasing the operational efficiency and quality control of a factory. Example implementations described herein are directed to an end to end solution which collects data from factory machines in real-time, streams data to a temporary storage to make real-time decisions, then streams data to a standardized storage location from where customized software applications targeting quality control, production efficiency and delivery planning are implemented using analytics and machine learning to cater to users ranging from the floor operator, to engineers, and to managers and executives. The solution involves a data aggregation platform, a database server to store the data in a easy to retrieve mechanism, an edge server to perform short term decisions using data analytics and machine learning, a cloud server to perform long term decisions using data analytics and machine learning, wherein the edge server is also used as a gateway to send decisions to control the machines and the cloud server to provide quality insights, performance and line availability metrics.

Aspects of the present disclosure can involve a system for management of a factory, involving a database server configured to intake and store streaming sensor data from a plurality of edge nodes of the factory, and manage historical data of the plurality of edge nodes of the factory; an edge server involving a first processor, configured to execute a first machine learning process on the streaming sensor data from the plurality of edge nodes to determine short term analytics; and control the plurality of edge nodes according to the determined short term analytics; and a cloud server involving a second processor, configured to execute a second machine learning process on the streaming sensor data stored in the database server and the short term analytics to determine long term analytics; and instruct the edge server to control the plurality of edge nodes according to the determined long term analytics.

Aspects of the present disclosure can involve a method for management of a factory, the method including intaking and storing streaming sensor data from a plurality of edge nodes of the factory in a database server, the database server managing historical data of the plurality of edge nodes of the factory; executing, at an edge server, a first machine learning process on the streaming sensor data from the plurality of edge nodes to determine short term analytics; controlling, at the edge server, the plurality of edge nodes according to the determined short term analytics; executing, at a cloud server, a second machine learning process on the streaming sensor data stored in the database server and the short term analytics to determine long term analytics; and instructing the edge server to control the plurality of edge nodes according to the determined long term analytics.

Aspects of the present disclosure can involve a system for management of a factory, the system including means for intaking and storing streaming sensor data from a plurality of edge nodes of the factory, means for managing historical data of the plurality of edge nodes of the factory; means for executing a first machine learning process on the streaming sensor data from the plurality of edge nodes to determine short term analytics; means for controlling the plurality of edge nodes according to the determined short term analytics; means for executing a second machine learning process on the streaming sensor data stored in the database server and the short term analytics to determine long term analytics; and means for controlling the plurality of edge nodes according to the determined long term analytics.

Aspects of the present disclosure can involve an edge server integrated in a system for management of a factory, the edge server including a processor, configured to execute a first machine learning process on the streaming sensor data from the plurality of edge nodes to determine short term analytics; control the plurality of edge nodes according to the determined short term analytics; and receive instructions from a cloud server to control the plurality of edge nodes according to long term analytics determined from a second machine learning process.

### BRIEF DESCRIPTION OF DRAWINGS

FIG. 1 illustrates an example of parameters for managing productivity in a factory, in accordance with an example implementation.

FIG. 2 illustrates an example of a smart manufacturing platform configured to estimate the OEE in an assembly style manufacturing operation, in accordance with an example implementation.

FIG. 3 illustrates an example of a central organized database in the database server, in accordance with an example implementation.

FIG. 4 illustrates an example of cloud machine learning functions on the cloud server, in accordance with an example implementation.

FIG. 5 illustrates an example of the cloud architecture for the smart manufacturing platform, in accordance with an example implementation.

FIG. 6 illustrates an example array of applications at different levels that can be facilitated with an end to end smart manufacturing tool, in accordance with an example implementation.

FIG. 7 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

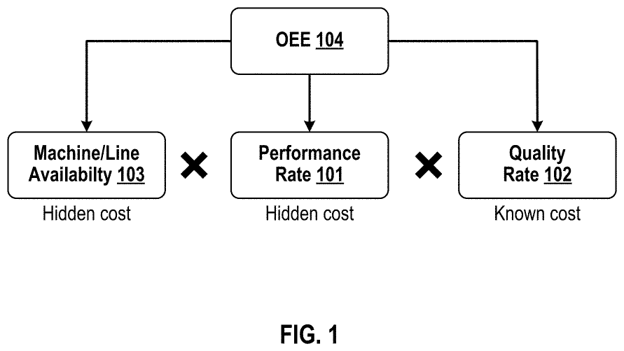

FIG. 1 illustrates an example of parameters for managing productivity in a factory, in accordance with an example implementation. In the current manufacturing process, to maintain high productivity in a factory, three parameters are managed, such as Performance Rate 101, Quality Rate 102, and Machine Availability 103. The product of above three parameters will yield Overall Equipment Effectiveness (OEE) 104 of the factory, which represents the productivity of a respective factory as shown in FIG. 1.

Performance Rate 101: To measure the performance rate in the factory, an open platform communications (OPC) server reading data from the manufacturing execution system/programmable logic controller (MES/PLC) related to each machine is setup on the data ingestion module. The OPC server pulls information related to number of parts processed per each machine and that is compared against the baseline target number of parts to be processed in a pre-determined amount of time which in turn provides the real real-time performance rate.

Quality Rate 102: To measure the quality rate in the factory, just like in the case of performance rate. The parameters responsible for the judgement of a component manufactured or processed on the assembly line are pulled from a quality inspection machine with the aid of an OPC server on a data ingestion module. The quality count as well corresponding quality metrics are stored in a database for understanding the process-quality relationship and then provide related quality insights for the factory staff.

Machine Availability 103: Machine availability is the percentage amount of time a machine is working without downtime caused by defects in the machine operation. The OPC server communicates with MES/PLC through an event-based trigger which relays information regarding the change in machine status, from which the current status of machine can be estimated, and corresponding machine availability can be calculated.

Example implementations can involve a current smart manufacturing platform that is implemented in a factory on the Electronic Control Unit (ECU) line to collect data from individual machines on the line and calculate respective performance rate, quality rate and machine availability, which in turn provides the operating equipment effectiveness or productivity of the factory.

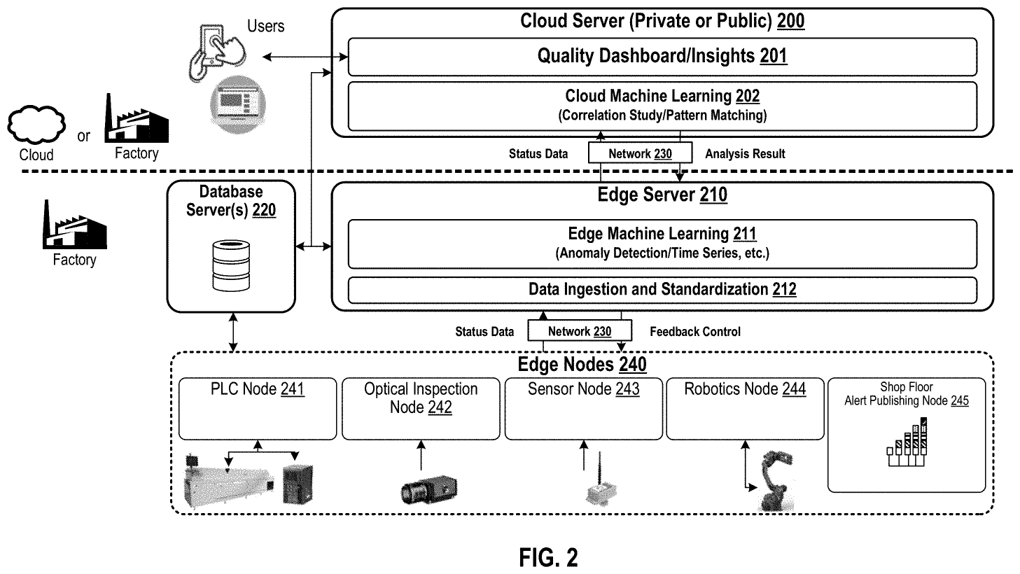

FIG. 2 illustrates an example of a smart manufacturing platform configured to estimate the OEE in an assembly style manufacturing operation, in accordance with an example implementation. Illustrated in FIG. 2 is a novel smart manufacturing platform integrating an edge server 210 conducting short term machine learning processes, database server(s) 220 configured to intake data from edge nodes 240 and edge server 210 and structure the data for machine learning processes, and a cloud server 200 configured to conduct long term machine learning processes. The smart manufacturing platform includes several modules which facilitate data flow from machine to a user graphical user interface (GUI) through edge 210 and cloud servers 200, the platforms also pass through analysis servers to make short term and long term decisions to users at different levels ranging from the machine operator to the factory executive. The platform can involve various modules, such as edge nodes 240 facilitating a data aggregation platform, and edge server 210 for short term decisions using the data analytics and the machine learning, the edge server 210 configured to function as a gateway to send decisions to control the machines, a database server 220 configured to store the data in an easy to retrieve mechanism, and a cloud server 200 for the long term decisions, the cloud server 200 configured to provide quality insights, performance and line availability metrics.

The edge nodes 240 facilitates a data aggregation platform involving distributed computing and a data storage platform which will connect to the various nodes on the factory floor such as programmable logic controller (PLC) nodes 241, optical inspection nodes 242, sensor nodes 243, robotics nodes 244, and alerts nodes 245.

The PLC nodes 241 are the control systems which govern the operation of a manufacturing machine/process on the factory floor. The PLC 241 controls sequence of operations, process deviations, possible alarms and downtime triggers based on the events occurring in the assembly or manufacturing process.

The optical inspection node 242 is a camera, visual or an infra-red based data acquisition method configured to capture the processing parameters of the manufacturing process and the optical inspection node also is used for capturing information related to 4M (Man, Machine Material and Method).

The sensor node 243 can be an invasive or a non-invasive sensor which can be used to measure the physical parameter which is a part of the operation of a manufacturing process and the deviation of the process parameters is responsible for quality defects or performance abnormality in the manufacturing process.

The robotics node 244 represents the semi or fully autonomous robot on the machine line which is subject to perform certain pre-determined operations.

The alerts node 245 is the mechanism used to pass information to the users in terms of flash emergency lights, text message, email or phone call to inform the current status of a manufacturing process using architecture such as a ISA95 type architecture.

The edge nodes 240 can involve a data aggregation platform that is connected to all the nodes either through a wired connection (Ethernet) or a wireless connection (WIFI, Bluetooth.). The data aggregation platform hosts an OPC server which connects to the PLC 241, robotics nodes 244 and an edge server 210 which connects to the optical inspection 242, sensor 243 and robotics nodes 244.

The data coming from the nodes is stored using the timestamp information which forms a sequential and organized structure of the data stream. The data stream is stored in a temporary low-volume database on the data aggregation platform to enable decisions based on short-term memory or historical information.

Edge server 210 is configured to handle short term decisions. As illustrated in FIG. 2, the edge server 210 is represented that the data flows from the edge nodes 240 to the edge server 210 via network 230 (e.g., Ethernet, wide area network, etc.) which is configured to facilitate functions such as data ingestion and standardization module 212, as well as edge machine learning 211. The edge machine learning 211 operates on the short-term historical information, such as but not limited to 5-6 hours of data used to make decisions such as process anomaly detection and process parameter deviation. The edge machine learning 211 allows the operators and engineers on the factory floor to make quick decisions about the insights provided by the edge server 210 for short term decisions.

Edge server 210 is also configured to function as a gateway to send decisions to control the machines of the factory. The analytics and machine learning 211 is implemented at the edge server 210 to derive insights into the data being generated from the edge nodes 240 on the factory floor. Based on the insights provided by the machine learning 211, at certain times there can be a need to send the signal to a machine on the factory floor to change the status of its operation to reduce the maintenance downtime, quality defects or performance deficiency. The signal from the edge server 210 is sent to the manufacturing machine as a trigger to stop the machine or as a code to the PLC 241 to modify certain parameters to alter the operational technique of the machine. In example of anomaly detection of an edge node 240 detected by edge machine learning 211, the edge server 210 can be configured to transmit instructions to control the corresponding edge node 240 to address the anomaly, such as instructing the edge node 240 to shut down at a designated schedule for maintenance, to send an alert, and so on.

Edge server 210 conducts machine learning processes to facilitate short term analytics. For example, suppose a machine controlled by a PLC node 241 has been changed to process new parts over the past hour. The machine learning processes of the edge server can be configured to identify the machine in the edge server 210 through the resulting short term data analytics (e.g., through detecting a shift in production results, image results, etc.). The short term data analytics information is provided to the database server 220, and the edge server 210 can utilize the short term data analytics to identify the type of new parts and determine results of the processing of the new parts, make corrections to the performance of the machine, or change the manufacturing pattern makers of the machine through transmission of instructions to the PLC node 241, which is then configured to control the machine according to the instructions.

Database server(s) 220 are configured to store the data. The data organized and standardized on the edge server is then sent to database in the cloud server. The database on the cloud server is setup to accept the standardized information at rapid time intervals (e.g., <1 ms) and simultaneously allow other applications to retrieve time series data (e.g., for up to a year worth of data) with minimum latency.

Cloud server(s) 200 are configured to conduct long term machine learning 202 to conduct correlation studies or pattern matching. In example implementations, the long term machine learning 202 conducts long term analytics on the data and short term analytics stored in the database server 220 to identify patterns in the data that are similar to patterns that have also occurred historically, cause and effect analysis stored in the database server 220 associated with those patterns, and any associated preventions, repairs, or management decisions that were taken to mitigate the issues, which can then be provided for output on the interface supporting the quality dashboard/insights 201. Long term analytics from the long term machine learning process 202 are also configured to determine any major defects that have been occurring over a long period of time (e.g., past few weeks, few months, etc.), the effect on the cost analysis, and any recommendations to improve or mitigate the defects that are causing problems with the underlying machines on the factory floor. Based on the long term analytics, cloud server(s) 200 can send an instruction to the edge server 210 to control the corresponding edge node 240 according to the long term analytics. In an example, if the long term analytics identify a pattern that indicates that production is decreasing and underlying edge nodes are coming close to the end of their remaining useful life, the cloud server 200 can instruct the edge server 210 to control the underlying edge node 240 to shut down at a certain schedule for maintenance.

Through the use of the novel structure of a database server, an edge server conducting machine learning processes for short term analytics to control the edge nodes, and a cloud server configured to conduct long term analytics to determine decisions for the factory floor, the edge nodes and machines on the factory floor can be efficiently controlled while analytics for the short term and the long term can be provided onto a dashboard.

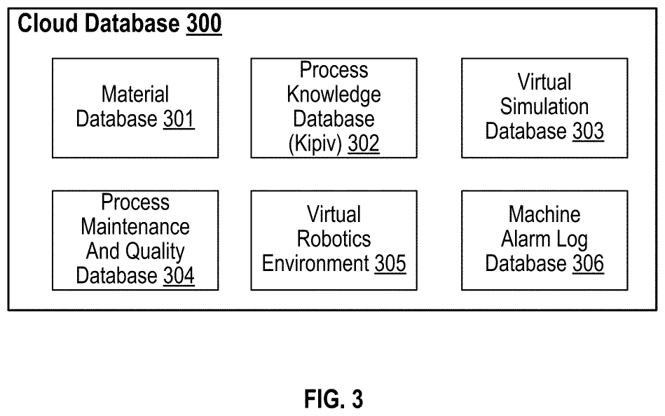

FIG. 3 illustrates an example of a central organized database in the database server 220, in accordance with an example implementation. The central organized database used as shown in FIG. 3 can be a structured query language (SQL) database or a Time Series Database (TSDB) or both. The database hosts information required for the maintenance and quality dashboards for different user roles simultaneously.

The cloud database 300 also can include database information related to materials 301, virtual simulation 303, robotics 305, alarm log 306 and user generated process knowledge database 302 as a benchmark or baseline reference for analytics study and making decisions related to quality and maintenance 304 of an operation on the factory floor. Materials database 301 manages various information regarding different material characteristics. Process knowledge database 302 manages information related to different manufacturing processes that are being conducted in a factory. Virtual simulation database 303 manages information and functions on which a user can perform certain levels of simulations related to the manufacturing processes.

Process maintenance and quality database 304 manages information provided by factory staff related to various defects that occur in the factory, which is reinforced over time. For example, the process maintenance and quality database 304 manages guide values or unique identifiers related to the entered defect, and as the information is being fed by the factory staff into these databases, the information is thereby reinforced to provide deeper and broader insight for the machine learning processes. Virtual robotics environment 305 is a function for users to set up a factory robot in a virtual environment and determine whether the robot will be able to perform a set of tasks and if the installation is optimal compared to factory staff for a given space. Machine alarm log database 306 is configured to manage all the alarms generated at the factory from various machines, along with any annotations provided from the factory staff for each triggered alarm. As such, when there is a reoccurrence of the alarm, the staff annotations can be made available regarding the previous conditions that occurred and how the alarm was addressed.

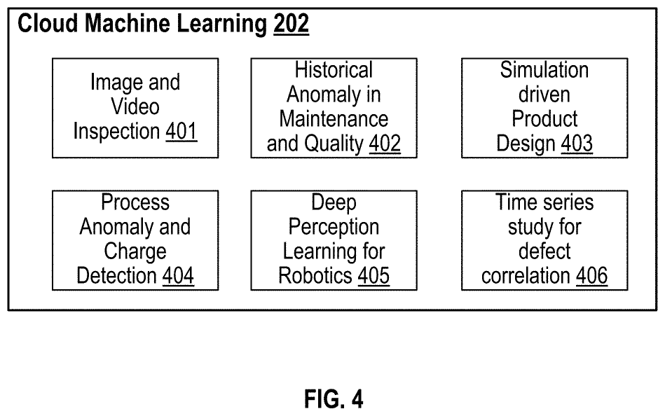

FIG. 4 illustrates an example of cloud machine learning functions 202 on the cloud server 200, in accordance with an example implementation. In this example, the cloud server 200 is configured to facilitate long term decisions and hosts machine learning and data analytics module 202 to provide deep insights into the maintenance and quality operations in the factory line. The types of analysis done by the cloud server 200 are shown in FIG. 4.

As illustrated in FIG. 4, there are various modules utilized by cloud machine learning 202 which use the data from the database server 220 and use the ground tools from the knowledge database 302 to learn machine learning methods. For example, there is image and video inspection 401 which can measure the timing of the actions conducted by the underlying staff or machines. Image and video inspection 401 can include algorithms that are used to track the worker moment and to create a safe environment, as well as inspection methods to keep count of the inventory in the factory.

Historical anomaly in maintenance and quality 402 is configured to track the patterns and history, determine when there is an anomaly in the performance, and then provide recommendations to the factory staff about when to take an action if needed. Simulation driven product design 403 is configured to intake the results of the simulations and determine a factory setup based on input design parameters. Process anomaly and change detection 404 is a function configured to detect changes in the process in case if the process is altered (e.g., by errant software update, by change in the machine programming, etc.) and provide indications to restore the process if necessary. Deep perception learning for robotics 405 is configured to intake constraints and feedback to teach a robot how to operate in a given space. Time series study for defect correlation 406 is configured to determine the correlation on the processes conducted by various machines and identify cause and effect relationships between a certain process on a machine upstream on the manufacturing line and certain process on a machine downstream on the manufacturing line.

The machine learning module on the cloud server 200 can be configured to perform image and video inspection 401 on the data/images obtained from the optical inspection node, historical anomaly in maintenance and quality using pattern recognition 402, simulation driven product design 403 using high fidelity system and component simulation tools, process anomaly and change detection 404 using leverage of knowledge database generated using user input information as shown in FIG. 3, deep perception learning for robotics 405 to mimic skilled operators and engineers to preserve the intuition related to a manual operation like welding or forming. and time series study 406 for tracking the historical progression of product quality and machine maintenance up to a period of one year.

The cloud server 200 can also be configured to provide quality insights, performance and line availability metrics, and can host a visual interface module 201 which translates the insights and decisions generated by the machine learning module 202 into an interactable interface for user at different levels/roles.

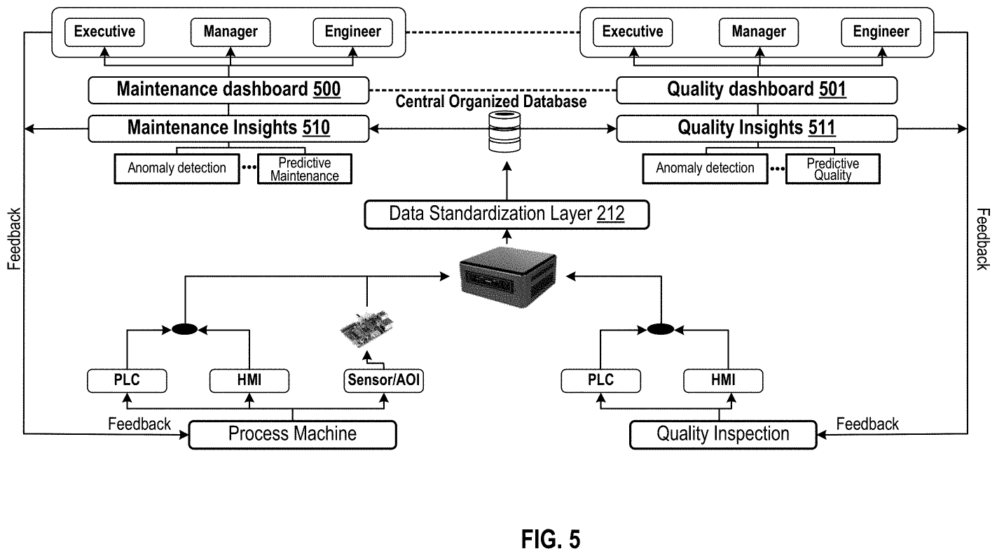

FIG. 5 illustrates an example of the cloud architecture for the smart manufacturing platform, in accordance with an example implementation. As illustrated in FIG. 5, the data from the central organized database after analysis and learning is represented in the maintenance dashboard 500 and quality dashboard 501 for the users to make decisions and to allow the users to be informed of the current status of the process with respect to the historical data.

The visual interface gives users options to drill down further into the datasets and allow manual analysis into the time series information related to the process and product. The visual interface also allows users to send out alerts to specific staff member sharing information with respect to a quality or maintenance insight to ensure speed dispatch and reduce the time required for manual intervention for a process station on the factory line.

After the dispatch has resolved the quality and maintenance issue, the dispatch can enter the resolution information through the interactive interface, which in turn is processed into the knowledge database making the existing process know-how of the process richer. Over time with regular inputs from the dispatch, the knowledge database becomes highly informative and provides the staff with an array of tools the next time a quality of maintenance defect has been observed at a processing machine.

As illustrated in FIG. 5, the system can involve various devices that convey information from the edge nodes to the edge server. One example device is the programming logic controller (PLC) which controls the manufacturing process of a machine and is configured to receive instructions from the edge server and control the machine accordingly. Human machine interfaces (HMIs) are interfaces with which user can interact with the machine by touch on the factory floor. Sensor and automated optical inspection (AOI) optical inspection are various sensors and cameras that measure images and other data from the underlying edge nodes. The data is collected and standardized in a data standardization layer 212 of the edge server to be stored in the database by the database server, wherein machine learning is conducted at the edge server to derive two types of analytics insights. Maintenance insights 510 are conducted to determine predictive maintenance and anomaly detection, whereas quality insights 511 are conducted to determine predictive quality and anomaly detection. These short term analytics insights can be presented in the form of a graphical user interface (GUI) to maintenance dashboard 500 or quality dashboard 501 to different levels of the factory (e.g., to GUI provided by cloud server 200 through quality dashboard/insights 201), from the factory staff to the engineer, manager, or executives to provide relevant key metrics and analytics so that factory efficiency can be tracked.

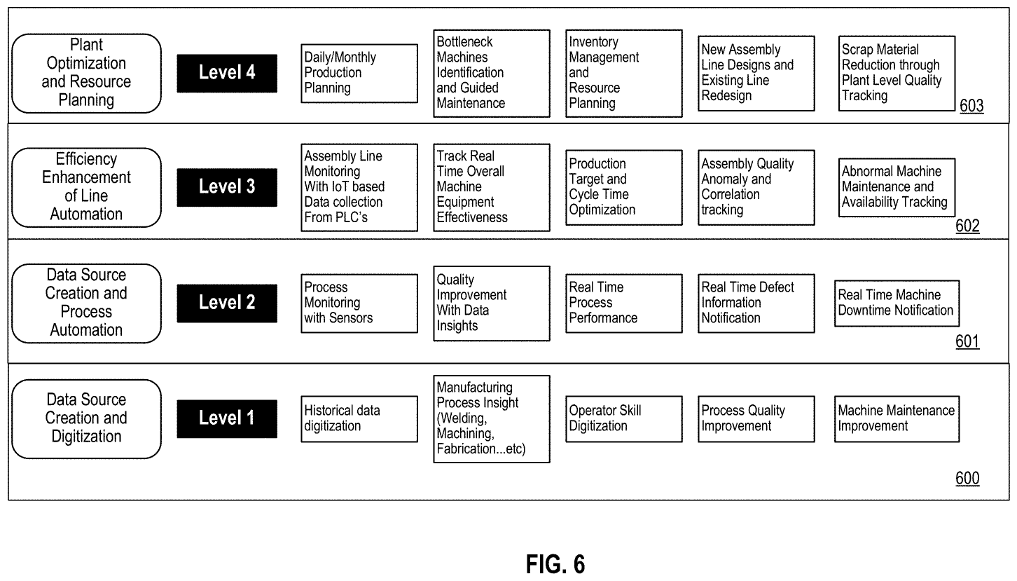

FIG. 6 illustrates an example array of applications at different levels that can be facilitated with an end to end smart manufacturing tool, in accordance with an example implementation. As illustrated in FIG. 6, Level 1 600 represents the applications possible with just installing monitoring systems with the goal of data source generation and digitization, Level 2 601 represents the possibility of automating the systems using the data sources installed on the process machines, Level 3 602 deals with connecting information from several machines on the factory floor with goal of enhancing the efficiency of line automation. Level 4 603 represents combining information from different lines on the factory floor to increase the inventory optimization and enterprise resource planning to increase the overall equipment effectiveness of the factory.

In an example, of level 1 application modules 600, the functions are configured to classify and provide analytics based on information received with the goal of data source generation and digitization, and can include functions such as historical data digitization processing site, process quality improvement, mission maintenance improvement, source generation and digitization, and so on.

Level 2 application modules 601 are configured to facilitate data source creation and automation based on feedback from the analytics conducted by the edge server. Feedback from the edge server is received after performing certain analytics to alter the performance category of the given machine, or from processing data makers of the given machine.

Level 3 application modules 602 are configured to facilitate efficiency enhancement of line automation. These application modules are invoked after several machines with data sources are created and then automation is processed on those machines. For the machines on a given manufacturing line, each individual machine is tapped and correlated to facilitate analytics such as assembly line monitoring, real time efficiency tracking, tracking performance rate using the production quality, and abnormal machine maintenance.

Level 4 application modules 603 are configured to combine the manufacturing lines to analyze the performance of the factory to facilitate analytics such as monthly production planning, identifying bottlenecks, quality and maintenance levels, and performing inventory management.

The implementation of a smart manufacturing solution will increase the OEE, which in turn will reduce the loss cost related to Man, Material and Energy. Reducing the loss cost will help allow companies to become profitable and environment friendly. The system can be implemented in the factory at three different levels. The first level is at shop floor where the system will be accessed using a tablet computer by a maintenance technician, who can utilize real time machine downtime and alarm information to diagnose the machine stoppage and recommend resolution. The second level is on a Laptop/personal computer with an engineer, who will investigate the daily, weekly and monthly statistics of quality and maintenance to make better predictions of line level productivity or OEE. The third level is by executives who use the information from smart manufacturing platform to make judgements about production planning and optimize the machines to throttle the production based on customer requirements.

The smart manufacturing platform will aid in building a knowledge database focusing on manufacturing process based on user input to enhance function of root-cause analysis. Due to the low-cost nature of the system, the return of investment for this technology is quite high and the system is highly flexible to be implemented in different forms of assembly line manufacturing lines maintaining same level of accuracy. With the implementation of the smart manufacturing platform, the loss cost of the production will be reduced benefitting the overall equipment efficiency.

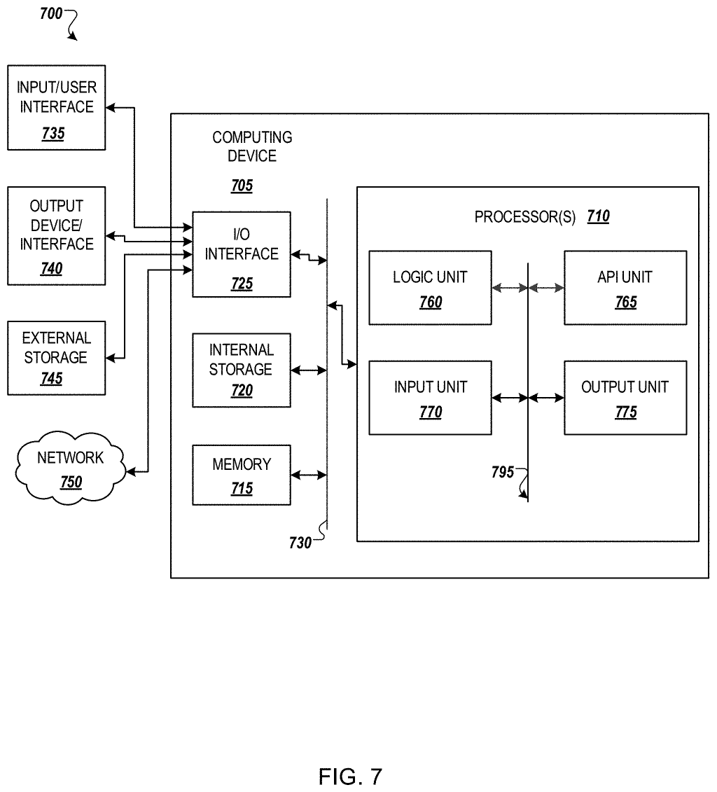

FIG. 7 illustrates an example computing environment with an example computer device suitable for use in some example implementations, such as an edge server, cloud server, or database server to facilitate a system for management of a factory as illustrated in FIG. 1. Computer device 705 in computing environment 700 can include one or more processing units, cores, or processors 710, memory 715 (e.g., RAM, ROM, and/or the like), internal storage 720 (e.g., magnetic, optical, solid state storage, and/or organic), and/or 10 interface 725, any of which can be coupled on a communication mechanism or bus 730 for communicating information or embedded in the computer device 705. 10 interface 725 is also configured to receive images from cameras or provide images to projectors or displays, depending on the desired implementation.

Computer device 705 can be communicatively coupled to input/user interface 735 and output device/interface 740. Either one or both of input/user interface 735 and output device/interface 740 can be a wired or wireless interface and can be detachable. Input/user interface 735 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 740 may include a display, television, monitor, printer, speaker, braille, or the like. In some example implementations, input/user interface 735 and output device/interface 740 can be embedded with or physically coupled to the computer device 705. In other example implementations, other computer devices may function as or provide the functions of input/user interface 735 and output device/interface 740 for a computer device 705.

Examples of computer device 705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 705 can be communicatively coupled (e.g., via IO interface 725) to external storage 745 and network 750 for communicating with any number of networked components, devices, and systems, including one or more computer devices of the same or different configuration. Computer device 705 or any connected computer device can be functioning as, providing services of, or referred to as a server, client, thin server, general machine, special-purpose machine, or another label.

IO interface 725 can include, but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, satellite network, and the like).

Computer device 705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 710 can execute under any operating system (OS) (not shown), in a native or virtual environment. One or more applications can be deployed that include logic unit 760, application programming interface (API) unit 765, input unit 770, output unit 775, and inter-unit communication mechanism 795 for the different units to communicate with each other, with the OS, and with other applications (not shown). The described units and elements can be varied in design, function, configuration, or implementation and are not limited to the descriptions provided. Processor(s) 710 can be in the form of hardware processors such as central processing units (CPUs) or in a combination of hardware and software units.

In some example implementations, when information or an execution instruction is received by API unit 765, it may be communicated to one or more other units (e.g., logic unit 760, input unit 770, output unit 775). In some instances, logic unit 760 may be configured to control the information flow among the units and direct the services provided by API unit 765, input unit 770, output unit 775, in some example implementations described above. For example, the flow of one or more processes or implementations may be controlled by logic unit 760 alone or in conjunction with API unit 765. The input unit 770 may be configured to obtain input for the calculations described in the example implementations, and the output unit 775 may be configured to provide output based on the calculations described in example implementations.

In an example implementation of a database server 220, processor(s) 710 can be configured to intake and store (e.g., into memory 705 streaming sensor data from a plurality of edge nodes 240 of the factory, and manage historical data of the plurality of edge nodes 240 of the factory as illustrated in FIG. 2 and FIG. 3. Processor(s) 710 can also be configured to the database server is configured to store the short term analytics determined by the first machine learning process and the long term analytics determined by the second machine learning process as illustrated in FIG. 2 and FIG. 3.

In an example implementation of an edge server 210, processor(s) 710 can be configured to execute a first machine learning process on the streaming sensor data from the plurality of edge nodes to determine short term analytics; and control the plurality of edge nodes according to the determined short term analytics as illustrated in FIGS. 2, 5 and 6. As an example, the first machine learning process is configured to conduct anomaly detection on the streaming sensor data from the plurality of edge nodes, and for an anomaly being detected by the first machine learning process, processor(s) 710 can be configured to store the anomaly detection as the short term analytics in the database server and control the plurality of edge nodes to address the anomaly.

In an example implementation of a cloud server 200, processor(s) 710 can be configured to execute a second machine learning process on the streaming sensor data stored in the database server and the short term analytics to determine long term analytics and instruct the edge server to control the plurality of edge nodes according to the determined long term analytics as illustrated in FIGS. 2, 4, 5, and 6. In an example implementation, the second machine learning process is configured to conduct pattern matching as the long term analytics on the historical data and the streaming sensor data in the database server with the short term analytics to determine past occurrences of anomalies indicated in the short term analytics, and the processor(s) 710 is configured to instruct the edge server to control the plurality of edge nodes according to the determined long term analytics and associated resolutions stored in the database server. Processor(s) 710 can also be configured to provide a graphical user interface (GUI) to provide the short term analytics and the long term analytics as illustrated in FIGS. 5 and 6.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A system for management of a factory, comprising:
a database server configured to intake and store streaming sensor data from a plurality of edge nodes of the factory, and manage historical data of the plurality of edge nodes of the factory;
an edge server comprising:
a first processor, configured to:
execute a first machine learning process on the streaming sensor data from the plurality of edge nodes to determine short term analytics; and
control the plurality of edge nodes according to the determined short term analytics;
a cloud server comprising:
a second processor, configured to:
execute a second machine learning process on the streaming sensor data stored in the database server and the short term analytics to determine long term analytics; and
instruct the edge server to control the plurality of edge nodes according to the determined long term analytics.

2. The system of claim 1, wherein the database server is configured to store the short term analytics determined by the first machine learning process and the long term analytics determined by the second machine learning process.

3. The system of claim 1, wherein the cloud server is configured to provide a graphical user interface (GUI) to provide the short term analytics and the long term analytics.

4. The system of claim 1, wherein the first machine learning process is configured to conduct anomaly detection on the streaming sensor data from the plurality of edge nodes, and for an anomaly being detected by the first machine learning process, the first processor is configured to store the anomaly detection as the short term analytics in the database server and control the plurality of edge nodes to address the anomaly.

5. The system of claim 1, wherein the second machine learning process is configured to conduct pattern matching as the long term analytics on the historical data and the streaming sensor data in the database server with the short term analytics to determine past occurrences of anomalies indicated in the short term analytics, and the second processor is configured to instruct the edge server to control the plurality of edge nodes according to the determined long term analytics and associated resolutions stored in the database server.

6. A method for management of a factory, the method comprising:
intaking and storing streaming sensor data from a plurality of edge nodes of the factory in a database server, the database server managing historical data of the plurality of edge nodes of the factory;
executing, at an edge server, a first machine learning process on the streaming sensor data from the plurality of edge nodes to determine short term analytics;
controlling, at the edge server, the plurality of edge nodes according to the determined short term analytics;
executing, at a cloud server, a second machine learning process on the streaming sensor data stored in the database server and the short term analytics to determine long term analytics; and
instructing the edge server to control the plurality of edge nodes according to the determined long term analytics.

7. The method of claim 6, further comprising storing the short term analytics determined by the first machine learning process and the long term analytics determined by the second machine learning process at the database server.

8. The method of claim 6, further comprising providing a graphical user interface (GUI) to provide the short term analytics and the long term analytics at the cloud server.

9. The method of claim 6, wherein the first machine learning process is configured to conduct anomaly detection on the streaming sensor data from the plurality of edge nodes, and for an anomaly being detected by the first machine learning process, wherein the method further comprises storing the anomaly detection as the short term analytics in the database server and controlling the plurality of edge nodes to address the anomaly.

10. The method of claim 6, wherein the second machine learning process is configured to conduct pattern matching as the long term analytics on the historical data and the streaming sensor data in the database server with the short term analytics to determine past occurrences of anomalies indicated in the short term analytics, and wherein the method further comprises instructing the edge server to control the plurality of edge nodes according to the determined long term analytics and associated resolutions stored in the database server.

11. An edge server integrated in a system for management of a factory, the edge server comprising:
a processor, configured to:
execute a first machine learning process on the streaming sensor data from the plurality of edge nodes to determine short term analytics;
control the plurality of edge nodes according to the determined short term analytics; and
receive instructions from a cloud server to control the plurality of edge nodes according to long term analytics determined from a second machine learning process.

12. The edge server of claim 11, wherein the first machine learning process is configured to conduct anomaly detection on the streaming sensor data from the plurality of edge nodes, and for an anomaly being detected by the first machine learning process, the processor is configured to store the anomaly detection as the short term analytics in the database server and control the plurality of edge nodes to address the anomaly.
